(19) United States
(12) Patent Application Publication
(10) Pub. No.: US 2005/0045605 A1
(43) Pub. Date: Mar. 3, 2005

(54) Method and arrangement for laser engraving a substrate surface

(76) Inventor: Gerold Simke, Bischofswerda (DE)

Correspondence Address: BAKER & BOTTS, 30 ROCKEFELLER PLAZA, NEW YORK, NY, 10112, US

(21) Appl. No.: 10/491,382

(22) PCT Filed: Apr. 17, 2002
(86) PCT No.: PCT/DE02/03744

(30) Foreign Application Priority Data
Oct. 2, 2001 (DE) 101 48 759.2

(51) Int. Cl. B23K 26/38

(52) U.S. Cl. 219/121.69

(57) ABSTRACT

The invention, which relates to a method and an arrangement for producing a laser engraving in a surface of a substrate, in which case, during an engraving operation, a laser beam generated by a laser generator is shaped by means of beam shaping diaphragms, focused in a focusing unit and directed, in beam intervals or continuously, onto the surface to be engraved, is based on the object of enabling an individual and freely programmable laser engraving in the surface of a substrate with a reduction of the production and maintenance outlay. In respect of the method, this is achieved in that the substrate is moved during the engraving operation in an x-y plane lying perpendicular to the beam direction. In respect of the arrangement, it is provided that the substrate support can be moved in an x-y plane lying perpendicular to the direction of the laser beam.

The invention relates to a method for producing a laser engraving in a surface of a substrate, in which, during an engraving operation, a laser beam is directed, in beam intervals or continuously, onto the surface to be engraved, the substrate being moved during the engraving operation in an x-y plane lying perpendicular to the beam direction and movements of the laser beam in the x and y directions being superposed on the movements of the substrate.

### FIELD OF THE PRESENT INVENTION

U.S. Pat No. 6,121,574 describes a method of the type mentioned in the introduction, in which the substrate is moved during the engraving operation in an x-y plane lying perpendicular to the beam direction and movements of the laser beam in the x and y directions are superposed on the movements of the substrate.

### BACKGROUND OF THE INVENTION

DE 198 40 926 A1 describes an arrangement in which a plurality of laser beams are combined in a laser point. In this case, it is possible to move the substrate in the perpendicular z direction in order to compensate for different substrate heights and to keep the laser beam focused on the respective surface.

### SUMMARY OF THE PRESENT INVENTION

EP 0 601 857 A1 describes an arrangement having a laser generator. Excimer lasers which operate in the deep UV spectrum and have very good ablation properties are suitable for the engraving of transparent materials.

Beam shaping diaphragms are arranged in the beam path of the laser beam generated by the laser generator.

Said diaphragms on the one hand shield part of the laser beam in order to bring the latter into the shape for example of alphanumeric characters which are intended to be applied on the surface of a substrate. On the other hand, the beam shaping diaphragms serve to split the shaped laser beam into a plurality of partial beams which then ensure that the character to be engraved comprises a plurality of points produced by the partial beams, thereby considerably improving the legibility.

A focusing unit is provided for the imaging of the beam shaped in this way. Said focusing unit serves to focus the laser beam onto the surface of the substrate lying on the substrate support and thus to sharply image the character impressed via the beam shaping diaphragms, which character is then engraved in the surface by ablation.

During the engraving operation, the laser beam is either directed continuously onto the surface of the substrate or a so-called pulsed laser is used which irradiates the surface in beam intervals.

It has been found that this known arrangement and the method realized thereby is not very flexible since every character change also requires that the beam shaping diaphragms be changed. Moreover, a considerable part of the laser energy is reflected at the beam shaping diaphragms or converted into heat.

One possibility for attaining a faster and more flexible character change is presented in U.S. Pat. No. 4,194,814 A. This solution likewise provides the use of beam shaping masks arranged on a rotatable mask drum. Depending on the desired character, the corresponding mask part that shapes the character is rotated into the beam path of the laser beam.

In addition to the not inconsiderable mechanical outlay, this solution requires, in the case of wear of a mask part which, by way of example carries the character used most, that the entire mask drum be exchanged, thus giving rise to a considerable maintenance outlay.

The arrangement according to EP 0 601 857 A1 already described is also provided with a beam deflection unit in the form of a deflection mirror which deflects the laser beam in order to bring it onto the surface of the substrate. This deflection is effected in the beam path before passing through the planar field objective.

It is now known to use such a beam deflection unit for a programmable and flexible laser engraving by arranging the deflection mirror in a galvanometer head. With the aid of the galvanometer head, it is possible to move the laser beam within the inscription field on the surface of the substrate. The shape of the character to be imaged can thus be influenced by means of a movement of the galvanometer head and no longer exclusively by means of a beam shaping diaphragm.

In order to achieve an imaging of the laser beam on the entire inscription field, a planar field objective is used.

Such an arrangement and a method realized thereby exhibits the disadvantage, in particular in the case of the preferred laser spectrum, that such a planar field objective can only be produced in a very complicated manner and only short service lives can be achieved with it.

DE 37 28 622 C1 and DE 196 12 406 C2 disclose a method in which an information item that is visible macroscopically, that is essentially with the naked eye, has superposed on it or incorporated in it a macroscopically invisible information item. This information may be composed of a machine-readable form, such as a bar code, or be realized simply by omission of burn-in points or the realization of small and large burn-in points. Thus, either a machine-readable information item is produced which, however, cannot be produced with a tenable outlay by means of a laser technique, or the information range is very restricted with the omission of pixels.

The object of the invention is now to introduce an individual and freely programmable laser engraving in the surface of a substrate together with an invisible information item with a production time expenditure that is approximately identical to that of conventional laser engraving.

In respect of the method, this object is achieved in that the laser engraving comprises a macroscopic structure composed of a pattern of microscopic engraving elements, coded information items being impressed on the structure by means of macroscopically invisible deviations of the pattern from a desired pattern by virtue of the structure being produced by means of the x and y movement of the substrate and the deviations being produced by means of the x and y movements of the laser beam.

The shape of the character can thus be set by way of the movement of the substrate. It thus becomes possible to produce a wide variety of characters by means of a simple alteration of the movement program. This permits the production of so-called micro-engravings in which the characters comprise engraving points within a matrix. Information items are encrypted behind the presence or absence of engraving points within said matrix.

The simple changing of the pattern to be engraved by means of the method according to the invention allows even substrate-specific patterns to be engraved and furthermore micro-engravings to be used to engrave and thus store substrate-specific coded information items.

The superposition of the movements of the substrate with movements of the laser beam in the x and y directions makes it possible to minimize the required precision of the movement of the substrate, since the fine adjustment can be performed by the movement of the laser beam. On the other hand, this affords the advantage that additional movements can be applied during the engraving by the laser beam. It thus becomes possible to achieve a widening of the engraving lines by means of a circulation of the beam.

By virtue of the fact that the laser engraving comprises a macroscopic structure composed of a pattern of microscopic engraving elements, coded information items are impressed on the structure by means of macroscopically invisible deviations of the pattern from a desired pattern. This affords the possibility of invisible information items also being accommodated in a normally visible structure which, for its part, can convey visible information items. Said invisible information can then be read out again by corresponding magnification of the structure and by a comparison of the pattern, i.e. the actual pattern, with the desired pattern.

The information is introduced by means of two movements in that the structure is produced by means of the x and y movement of the substrate and the deviations are produced by means of the x and y movements of the laser beam. Since the deviations require only very small geometrical alterations of the position of the laser beam on the substrate surface which, however, have to be performed with some precision, it is expedient not to use the relatively sluggish movement of the substrate for this purpose, but rather to move the massless laser beam which can be done at higher speed and with greater precision.

A favorable refinement of the invention provides for the substrate to be moved during the engraving operation in a z direction lying parallel to the beam direction.

This refinement makes it possible to take account of different surface structures and/or different material thicknesses of the substrates.

In this case, it is particularly expedient for the movement in the z direction to be effected in a manner dependent on the structure of the surface. This is done in such a way that the focus of the laser beam always lies on the surface in the case of different positions of the substrate in the x-y plane.

In order to realize the z movement, it is possible to take account of a known surface structure of the substrates that are to be successively engraved in the case of a control program, as it were to fixedly program the surface structure. As a result, the z movement is then controlled in a manner dependent on the substrate position in the x-y plane.

Another possibility for controlling the z movement consists in regulating the focusing. In this case, the extent to which the laser beam is sharply imaged on the surface of the substrate is measured and the z movement is correspondingly initiated until the focus of the laser beam is imaged on the surface.

In another refinement of the method, the beam is shaped by means of beam shaping diaphragms and the shape of the beam shaping diaphragms is sharply imaged as an engraving point on the surface. It is thus possible to use different beam shaping diaphragms to produce engraving points with a particular shape which, by way of example, are particularly suitable for automatic recognition.

A further refinement of the method provides for the movements of the substrate to be effected discontinuously. This enables a pointwise engraving to be effected in such a way that the substrate remains in a first position, then is moved into the next position, remains there again, etc.

A further refinement of the discontinuous movement consists in the fact that, in the case of beam intervals being used, the movements are effected in temporal interspaces between the beam intervals. A step-by-step operation is thus realized: a laser pulse with relatively high energy produces the point-like engraving during a pulse interval. After the laser pulse and before the next one, the position of the substrate is altered. This affords the advantage that it is possible to work with relatively high radiation energy, and that the engraving points are imaged very precisely since an ablation on the surface of the substrate is avoided during the method.

It is furthermore possible for the laser engraving to comprise a multiplicity of macroscopic structures. It is thus possible, by way of example, for visible points to be strung together. In this case, the individual structures may in turn serve for the grouping of information items.

It is expedient for the desired pattern to be chosen as a matrix of set or non-set engraving elements. The deviations are then formed by omission or addition or of engraving elements. This matrix is visible as a small point or small quadrangle. In this case, it is possible to achieve a high information density on a very small geometrical area. Due to the small geometrical extent of the matrix, the information items can also be stored on curved surfaces since, on account of the small geometrical extent, only an insignificant spatial extension of the structure arises even in the case of a high degree of curvature. This considerably facilitates both the writing and the reading of the information.

It is possible for the matrix to be provided with a matrix frame made of engraving elements. The matrix thus always appears as a geometrical structure in the macroscopic range, irrespective of the number of introduced or missing engraving elements. Such a matrix frame also precisely defines the limits of the matrix.

A further refinement of the method provides for the desired pattern to be chosen as engraving elements lying on a line and the deviations to be formed by means of a macroscopically invisible offset of the engraving elements from the line. Such a line appears straight to the observer since he does not perceive the offset even though still further information is stored invisibly in the line itself.

One variant in this respect provides for the desired pattern to be chosen as engraving elements lying one behind the other on a double line, the line spacing thereof lying in the microscopic range. In this case, the engraving elements lie on one line of the double line in the case of the representation of a logic 0 in the coded information item and lie on the other line of the double line in the case of the representation of a logic 1. This results in a precise assignment of the lateral offset and hence an increase in the recognition accuracy.

Through omission of engraving elements on one line or the other, it is then possible for the information even to be doubly binary encrypted.

The invention will be explained in more detail below using an exemplary embodiment. In the associated drawings:

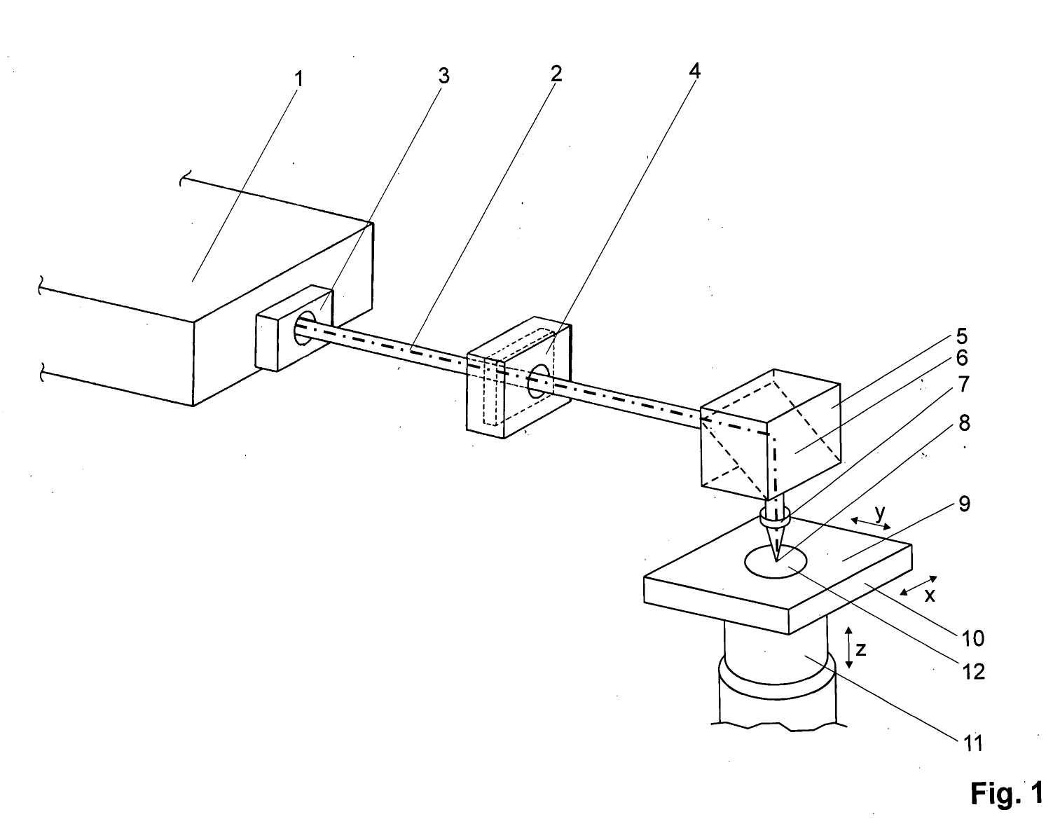

FIG. 1 shows a perspective illustration of an arrangement according to the invention with a simple beam deflection unit,

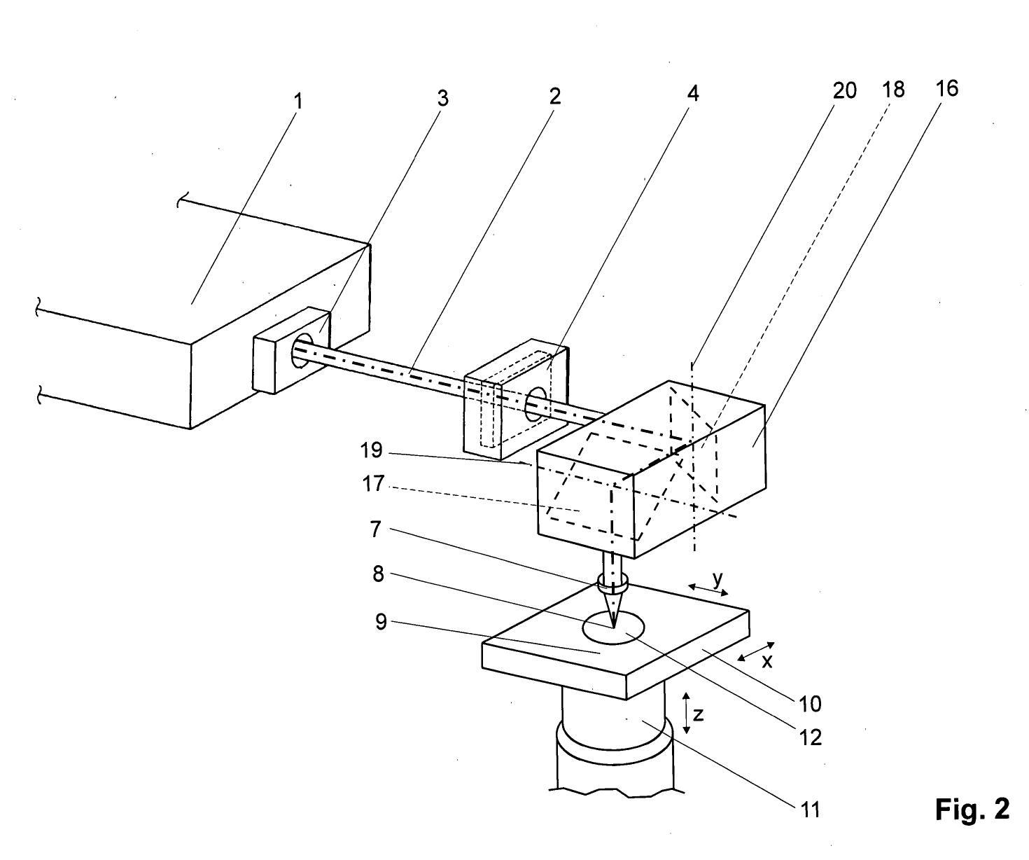

FIG. 2 shows a perspective illustration of an arrangement according to the invention with a galvanometer head,

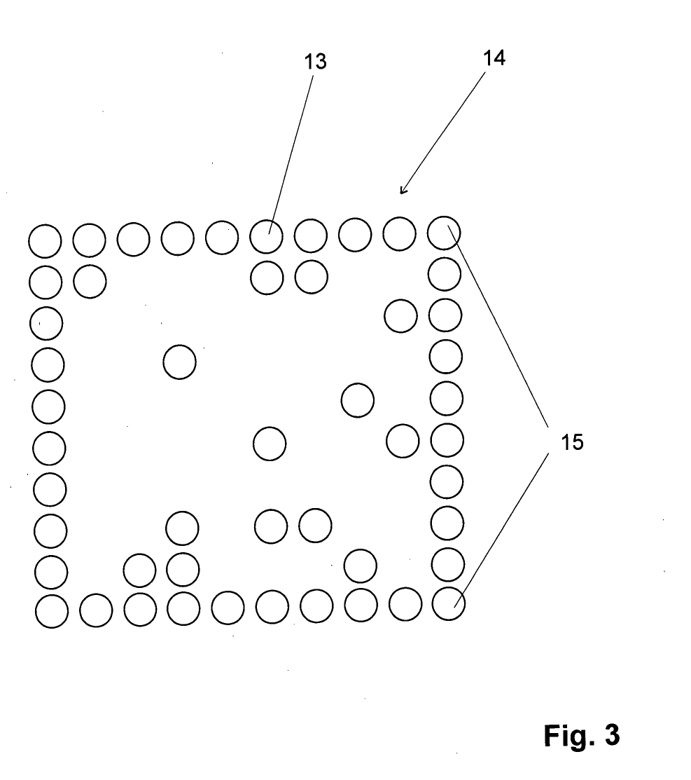

FIG. 3 shows an illustration of a micro engraving in the form of a matrix produced by the method according to the invention, and

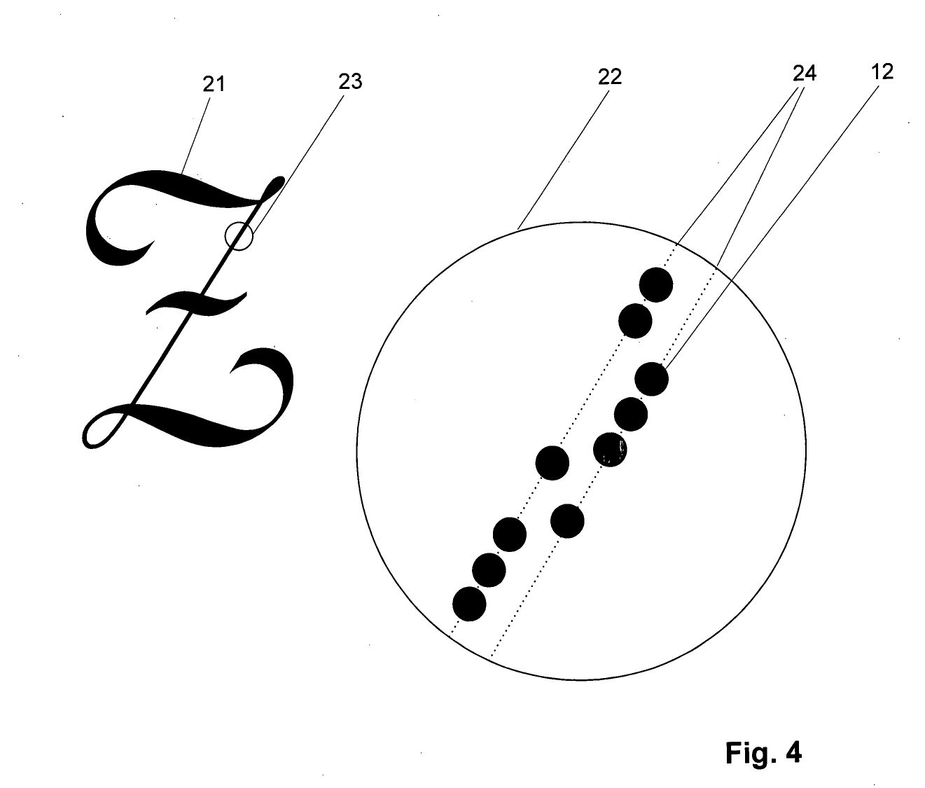

FIG. 4 shows the illustration of a macroscopic structure with a microscopic pattern containing an information item.

The arrangement illustrated in FIG. 1 has a laser generator 1, which generates a laser beam 2. Said laser beam 2 passes through a beam shaping diaphragm 3 formed as a perforated screen. Said beam shaping diaphragm 3 shapes the laser beam 2 with a sharply delimited circular cross section. It can thus be imaged with good quality later.

The laser beam 2 experiences another shape correction in a correction diaphragm 4.

In the further beam path, the laser beam passes through a beam deflection unit 5, in which a deflection mirror 6 is arranged, which deflects the laser beam 2 perpendicular to its previous direction.

This deflected laser beam 2 is focused in a focusing unit 7 comprising a simple focusing lens, which is connected to the beam deflection unit 5.

A substrate support 9 connected to an x-y compound table 10 is provided below the focus 8. Said x-y compound table 10 can be moved in an x-y plane which is determined by the movement directions x and y and which lies perpendicular to the direction of the deflected laser beam 2.

A z drive 0 is additionally provided below the x-y compound table 10, and can be used to move the x-y compound table 10 and thus the substrate support 9 in a z direction lying parallel to the laser beam 2.

This arrangement permits the production of a so-called micro-engraving, as is illustrated in FIG. 3, on a substrate 12 which bears on the substrate support 9 and is fixed there in a manner that is not illustrated in greater detail. Said micro-engraving comprises engraving elements which, in this example, are embodied as engraving points 13 . However, said engraving elements may also have other shapes, the choice of shape also actually being able to contain an item of information.

The engraving points 13 are arranged within a matrix 14. Information items, e.g. about the substrate 12, are encrypted behind the presence or absence of engraving points 13 within said matrix 14, in that the pattern produced by the engraving points 13 within the matrix 14 deviates from a desired pattern, which in that case would correspond to the matrix 14 completely filled in. For precise definition, the matrix 14 is provided with a matrix frame 15. The engraving points 13 in the matrix frame 15 are not available for an information coding.

At the locations within the matrix 14 at which an engraving point 13 is to be produced, the x-y compound table 10 moves the substrate 12 under the focus 8, so that the focus 8 lies at the engraving point 13 to be produced. Since the substrate 12 is not planar, precise setting of the focus 8 is effected by means of the z drive 11.

The substrate 12 remains in this position until the engraving point 13 has been produced. Afterward, the same procedure is effected at the next engraving point 13 to be produced in the matrix 14.

As becomes evident from the method, the positioning of the focus 8 on the substrate 12 requires a high accuracy which has to be realized by the x-y compound table 10. This requires a high production outlay and also entails longer positioning times.

In order to avoid this, in FIG. 2 the arrangement is provided with a galvanometer head 16 instead of the beam deflection unit 5 in FIG. 1. The galvanometer head 16 comprises a first galvanometer mirror 17 and a second galvanometer mirror 18. The first galvanometer mirror 17 can be pivoted about a first axis 19, which lies perpendicular to the direction of the non-deflected laser beam 2 and parallel to an x-y plane. The second galvanometer mirror 18 can be pivoted about a second axis 20, which lies perpendicular to the direction of the non-deflected laser beam 2 perpendicular to the x-y plane. The x-y plane is an imaginary plane (not illustrated) extending in the x and y directions.

The galvanometer mirrors 17 and 18 are magnetically biased and deflected by an electric field. It thus becomes possible to perform deflections of the focus 8 at high speeds and with high precision. By means of this arrangement, a movement of the focus 8 can be superposed on the movement of the substrate 12. It thus becomes significantly more readily possible to produce the only microscopically visible deviations of the pattern of engraving points 13. The electrical driving of the galvanometer mirrors 17 and 18 also affords the possibility that the information can be written directly from a computation device.

As illustrated in FIG. 4, the laser engraving comprises a macroscopic structure 21 composed of a pattern of engraving points 13. In this case, coded information items have been impressed on the structure 21 by means of macroscopically invisible deviations of the pattern from a desired pattern.

As can be seen in the enlargement 22 of a detail 23 from the structure 21, the pattern is embodied as engraving points 13 lying one behind the other on a double line 24. The line spacing of the double line 24 lies in the microscopic range. In this case, the engraving points 13 lie on one line of the double line 24 in the case of the representation of a logic 0 in the coded information item and lie on the other line of the double line 24 in the case of the representation of a logic 1.

1. A method for producing a laser engraving in a surface of a substrate, in which, during an engraving operation, a laser beam is directed, in beam intervals or continuously, onto the surface to be engraved, the substrate being moved during the engraving operation in an x-y plane lying perpendicular to the beam direction and movements of the laser beam in the x and y directions being superposed on the movements of the substrate, characterized in that the laser engraving comprises a macroscopic structure composed of a pattern of microscopic engraving elements, coded information items being impressed on the structure by means of macroscopically invisible deviations of the pattern from a desired pattern by virtue of the structure being produced by means of the x and y movement of the substrate and the deviations being produced by means of the x and y movements of the laser beam.

2. The method as claimed in claim 1, wherein the substrate is moved during the engraving operation in a z direction lying parallel to the beam direction.

3. The method as claimed in claim 2, wherein the movement in the z direction is effected in a manner dependent on the structure of the surface, in such a way that the focus of the laser beam always lies on the surface in the case of different positions of the substrate in the x-y plane.

4. The method as claimed in claim 2, wherein the beam is shaped by means of beam shaping diaphragms and the shape of the beam shaping diaphragms is sharply imaged as an engraving point on the surface.

5. The method as claimed in claim 1, wherein the movements of substrate are effected discontinuously.

6. The method as claimed in claim 5, wherein, in the case of beam intervals being used, the movements are effected in temporal interspaces between the beam intervals.

7. The method as claimed in claim 1, wherein the laser engraving comprises a multiplicity of macroscopic structures.

8. The method as claimed in claim 1, wherein the desired pattern is chosen as a matrix of set or non-set engraving elements and the deviations are formed by omission or addition or of engraving elements.

9. The method as claimed in claim 8, wherein the matrix is provided with a matrix frame made of engraving elements.

10. The method as claimed in claim 1, wherein the desired pattern is chosen as engraving elements lying on a line and the deviations are formed by means of a macroscopically invisible offset of the engraving elements from the line.

11. The method as claimed in claim 10, characterized in that the desired pattern is chosen as engraving elements lying one behind the other on a double line the line spacing thereof lying in the microscopic range, the engraving elements lying on one line of the double line in the case of the representation of a logic 0 in the coded information item and lying on the other line of the double line in the case of the representation of a logic 1.

12. The method as claimed in claim 2, wherein the movements of substrate are effected discontinuously.

13. The method as claimed in claim 3, wherein the movements of substrate are effected discontinuously.

14. The method as claimed in claim 4, wherein the movements of substrate are effected discontinuously.

15. The method as claimed in claim 2, wherein the desired pattern is chosen as a matrix of set or non-set engraving elements and the deviations are formed by omission or addition or of engraving elements.

16. The method as claimed in claim 3, wherein the desired pattern is chosen as a matrix of set or non-set engraving elements and the deviations are formed by omission or addition or of engraving elements.

17. The method as claimed in claim 2, wherein the desired pattern is chosen as engraving elements lying on a line and the deviations are formed by means of a macroscopically invisible offset of the engraving elements from the line.

18. The method as claimed in claim 3, wherein the desired pattern is chosen as engraving elements lying on a line and the deviations are formed by means of a macroscopically invisible offset of the engraving elements from the line.

19. The method as claimed in claim 4, wherein the desired pattern is chosen as engraving elements lying on a line and the deviations are formed by means of a macroscopically invisible offset of the engraving elements from the line.

20. The method as claimed in claim 5, wherein the desired pattern is chosen as engraving elements lying on a line and the deviations are formed by means of a macroscopically invisible offset of the engraving elements from the line.

21. The method as claimed in claim 6, wherein the desired pattern is chosen as engraving elements lying on a line and the deviations are formed by means of a macroscopically invisible offset of the engraving elements from the line.
